(19) United States
(12) Patent Application Publication
(10) Pub. No.: US 2015/0229259 A1
(43) Pub. Date: Aug. 13, 2015

(54) ENERGY SAVING METHOD AND SYSTEM FOR MOTOR DRIVEN SYSTEMS

(71) Applicant: Rhombus Energy Solutions, Inc., San Diego, CA (US)

(72) Inventors: Gholamreza ESMAILI, San Diego, CA (US); Kevin Michael Clark, San Diego, CA (US)

(21) Appl. No.: 14/175,177

(22) Filed: Feb. 7, 2014

(51) Int. Cl. H02P 23/00

(52) U.S. Cl. CPC H02P 23/0081

(57) ABSTRACT

An energy reducing device/system for AC motors. A processor controls the chopping angle of a connected switch, having an initialization module, assigning initial values for the chopping angle, adjustment step, and determining initial motor power value; application module, applying an adjusted chopping angle, corresponding to the initial chopping angle plus the adjustment step, to the switch; calculation and measurement module, calculating phase lag corresponding to the adjusted chopping angle, measuring current power and calculating current power to previous power difference; chopping angle adjustment module, adjusting the chopping angle according to the previous chopping angle step, adjustment step and power difference; and motor on module, determining, if the motor is on, to loop back to the application module with the adjusted chopping angle, wherein the device reduces energy usage by iterating to a phase angle that is substantially at a power usage curve minimum for the load.

### FIELD

This invention relates to reduced energy consumption approaches for active single or three phase systems under varying load conditions. More particularly, it relates to efficiently reducing power consumption for low load conditions for electrically motorized systems.

### BACKGROUND

All electrical motors incur unavoidable losses during operation, for example, ferromagnetic motors incur “iron” loss from the core, which is known to be proportional to the square of the applied voltage. Similarly, copper losses are incurred for the windings of motors. These losses can be as high 15% of the total power used. For continuously motor driven systems such as escalators, moving sidewalks, public systems, etc., it known that significant periods of system operation are under low load (for example, at night to early morning), and may not be operating under optimum efficiency. If these no/low load condition periods represent a large portion of the motor operation, the cost of running these systems at low/no load can be substantial, especially for less efficient legacy systems such as public escalators, etc. Also, is it is well understood that motors during startup incur large, potentially damaging inrush currents which the industry has taken numerous steps to minimize, all of which introduce additional concerns.

In view of the above, there has been a long need in the industry for methods and systems to more efficiently control the power consumed in motor driven systems while under no/low load conditions as well as other conditions. Accordingly, aspects of new methods and systems addressing these and other deficiencies in the prior art are elucidated in the following description.

### SUMMARY

The following presents a simplified summary in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

In one aspect of the disclosed embodiments, an energy reducing device for an electrically powered motor is provided, comprising: at least one controllable electrical switch configured to be connected between an alternating power source and a motor driven by the alternating power source; a processor in communication with the at least one controllable electrical switch, controlling a chopping angle operation thereof; and processor-readable instructions for controlling the at least one controllable electrical switch, comprising: an initialization module, assigning initial values for a chopping angle and adjustment step, and determining an initial motor power value; an application module, applying an adjusted chopping angle, corresponding to the initial chopping angle plus the adjustment step, to the at least one controllable electrical switch; a calculation and measurement module, calculating phase lag corresponding to the adjusted chopping angle, measuring current power value and calculating a difference between the current power value and a previous power value; chopping angle adjustment module, adjusting the chopping angle according to the previous chopping angle step, adjustment step and calculated power difference; and motor on module, determining, if a connected motor is on, to loop back to the application module with the adjusted chopping angle, wherein the device reduces energy usage by iterating to a phase angle that is substantially at a minimum of a power usage curve for a motor load.

In other aspects of the disclosed embodiments, the above energy reducing device is provided, wherein the chopping angle adjustment module adjusts the chopping angle Δγ according to Δγ=−Sign(Δγ_{current})·Sign(ΔP)·γₛₜₑₚ, where Δγ_{current} is a current value, ΔP is the different between the current power value and previous power value, and the Sign(f) function is =1, f≧0, and =0, f<0; and/or wherein the adjustment step is variable; and/or wherein the at least one controllable electrical switch is a high voltage semiconductor switch and capable of controlling over a ¼hp motor and/or over 1 Kwatt of power; and/or wherein the at least one controllable electrical switch is comprised of a parallel pair of opposing thyristors; and/or further comprising, an alternating power source that is at least one of a single phase power source and multiple-phase power source coupled to the device; and/or further comprising, at least one of a single phase motor and multiple phase motor coupled to the device; and/or wherein at least one of the at least one controllable electrical switch and processor is embedded into the at least one single phase motor and multiple phase motor; and/or wherein the motor load is variable; and/or wherein the processor is in wireless communication with the at least one controllable electrical switch; and/or further comprising a power measurement tap separate from the at least one controllable electrical switch.

In another aspect of the disclosed embodiments, a method for reducing energy usage for an electrically powered motor is provided, comprising: connecting at least one controllable electrical switch between an alternating power source and a motor driven by the alternating power source; connecting a processor in communication with the at least one controllable electrical switch, controlling a chopping angle operation thereof via the steps comprising: automatically assigning, via processor instructions, initial values for a chopping angle and adjustment step, and determining an initial motor power value; automatically applying, via processor instructions, an adjusted chopping angle, corresponding to the initial chopping angle plus the adjustment step, to the at least one controllable electrical switch; automatically calculating, via processor instructions, a phase lag corresponding to the adjusted chopping angle; automatically measuring, via processor instructions, current power value; automatically calculating, via processor instructions, a difference between the current power value and a previous power value; automatically adjusting, via processor instructions, the chopping angle according to the previous chopping angle step, adjustment step and calculated power difference; and automatically determining, via processor instructions, if a connected motor is on, to loop back to the application module with the adjusted chopping angle, wherein the method reduces energy usage by iterating to a phase angle that is substantially at a minimum of a power usage curve for a motor load.

In other aspects of the disclosed embodiments, the above energy reducing method is provided, wherein the automatically adjusting adjusts the chopping angle Δγ according to Δγ=−Sign(Δγ_{current})·Sign(ΔP)·γₛₜₑₚ, where Δγ_{current} is a current value, ΔP is the different between the current power value and previous power value, and the Sign(f) function is =1, f≧0, and =0, f<0; and/or wherein the adjustment step is variable; and/or wherein the at least one controllable electrical switch is a high voltage semiconductor switch and capable of controlling over a ¼hp motor and/or over 1 Kwatt of power; and/or at least one of a single phase power source and multiple-phase power source to a power source side of the at least one controllable electrical switch; and/or further comprising, coupling at least one of a single phase motor and multiple phase motor to a load side of the at least one controllable electrical switch; and/or wherein the processor is in wireless communication with the electrical switch; and/or further comprising, taking a power measurement at the motor.

### BRIEF DESCRIPTION OF THE DRAWINGS

FIG. 1A is a prior art plot of initial inrush current and voltage in a typical motor upon start up.

FIG. 1B is a prior art plot of FIG. 1A, but expanded out to a longer time period.

FIG. 2A is a schematic of a switching embodiment for use in single-phase motorized systems.

FIG. 2B is a schematic of a switching embodiment for use in three-phase motorized systems.

FIG. 2C is a schematic of thyristor embodiment suitable as a controllable switch for the embodiments of FIGS. 2A-B.

FIG. 3 is a plot showing modified voltage and current profiles for a single-phase motorized system under control.

FIG. 4 is a graphical example of fixed-increment/decrement angle paths over power load curves in accordance with the described embodiments.

FIG. 5 is a flow chart illustrating a process for adjusting the angle using a fixed adjustment amount approach.

FIG. 6A is a block diagram illustrating a motor system embodiment with a separate controller.

FIG. 6B is a block diagram illustrating another motor system embodiment with an embedded controller.

### DETAILED DESCRIPTION

For ease of explanation, the body of this discussion is described in the context of motors (inductive systems), being the most direct and ubiquitous device(s) for implementing the methods and systems described herein. However, it is understood that capacitive systems can equally be subjected to the described approaches, by reversing the phase lag to phase lead relationships described herein. Also, for ease of description, the phrase “no load” will be used as the general term to describe either no load and/or low load.

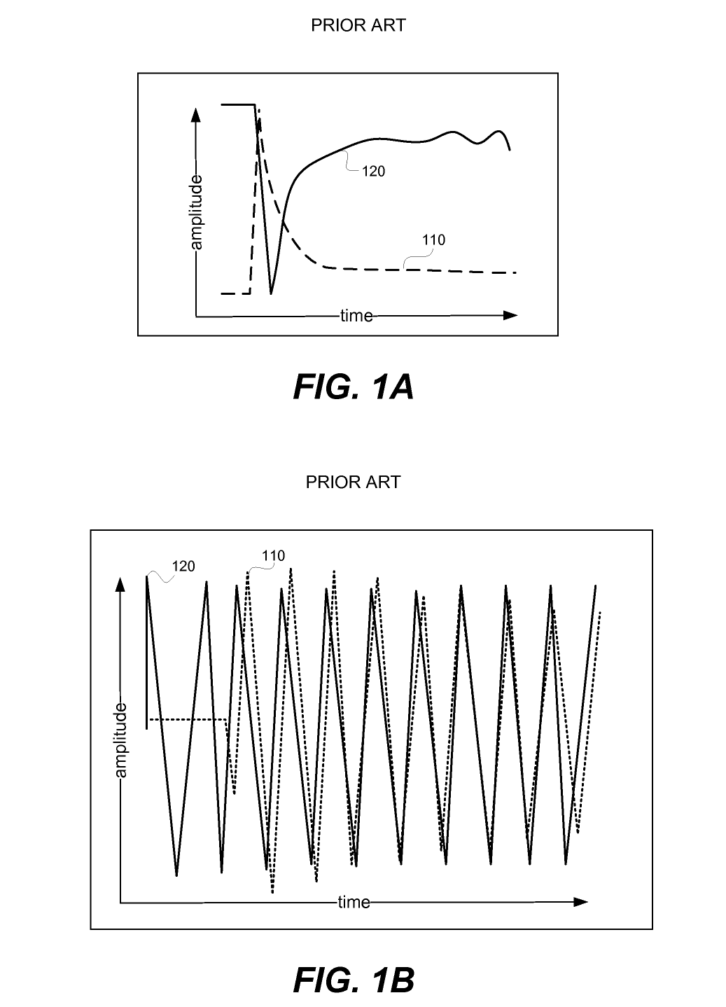

FIG. 1A is a prior art plot 100 of inrush current 110 to voltage 120 in a typical motor upon start up, illustrating the “first” cycle of the current/voltage waveform swings. FIG. 1B is a prior art plot 150 of FIG. 1A, but expanded out to a longer time period, illustrating the gradual stabilization to steady state levels of the current/voltage 110/120 waveforms. Evident from these FIGS. is the fact that motors have the undesirable trait of drawing several times their full load current while starting (e.g. inrush current). This large inrush current can cause damage to motor winding and circuit breakers and electrical equipment's connected to the motor.

To fully appreciate the invention, a brief introduction to phase lag, in the context of motors is presented. Motors, when in operation, are similar to inductive loads because of the coil windings in each phase of the machine. Therefore, there is an inherent phase lag between the voltage and current of each phase. However, the current's phase lag will vary depending on the load connected to the motor (shaft). As shaft load increases, more electrical power is consumed by the motor, which results in the phase lag to reduce. As loads present different power to phase lag profiles to the motor, the power drawn by the motor may not be at the profile's minimum point, resulting in increased losses. Attempts have been made in the industry to compensate for motor lag via capacitive banks, which bring their own set of problems. Therefore, what is universally desired in the industry is a simple and robust approach to reducing power consumption (e.g. reduce phase lag) without affecting the motor's ability to respond to loads.

One approach presented here is, while the motor is in “steady state” operation, to elegantly adjust the phase lag to arrive at the minimum phase lag point/minimum power loss for the load at hand. By reason of extension, this approach can also be applied to soft starting the motor.

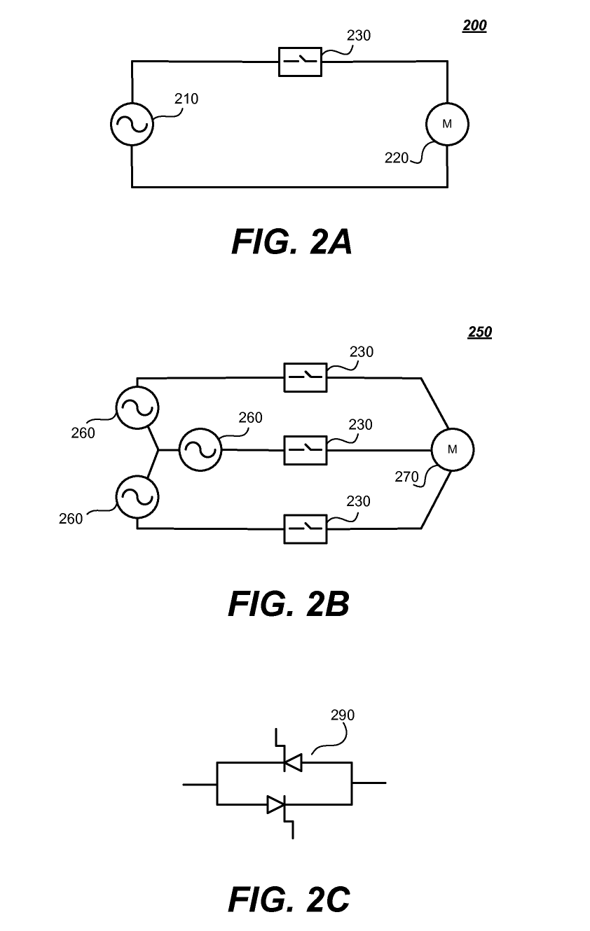

FIGS. 2A and 2B are schematics of general switching embodiments 200, 250 suitable for use in single-phase and three-phase motorized systems. However, this method can be applied to a motor with any number of phases, for example 5-phase and 6-phase motors. FIG. 2A's embodiment is composed of a single AC source 210 connected to motor (aka load) 220 via a path interrupted by controllable switch 230. FIG. 2B's embodiment is composed of a three-phase AC source 260 connected to three-phase motor (aka load) 270 via individual phase leg controllable switches 230. The switches 230 are switched in such a specified manner to control the flow of power to the motor, as further detailed below. For AC-based systems, the switches 230 must be capable of controlling the flow of current/voltage in both directions.

The switch 230 can be facilitated by a simple latching switch, for example, having high speed mechanical opening and closing capabilities. However, a very effective semiconductor switch having equivalent capabilities can be found in thyristors 290, for example, as shown in FIG. 2C. By pairing in reverse order two thyristors, bi-directional (e.g., AC) control can be obtained and the controllable characteristic of thyristors lend themselves to rapid turning on or off, via software control. The activation process is referred to as “firing” the thyristor, the duration of which being expressed as an angle—corresponding to the equivalent delay in degrees in a time-synchronous (AC) power system. It should be appreciated that though thyristors have been shown as one example of an applicable power switching device, other applicable solid state switching devices may be employed, without departing from the spirit and scope of this disclosure. For example, diodes with controllable switches, so forth, may act as a proxy to the thyristors.

Noting that in high power embodiments, such as over 1 KWatt, switches capable of handling high current/high voltage are needed as well as the ability to rapidly switch on and off. For example, switches capable of controlling over ¼hp motors, running in single phase or multiple phase (e.g., 110V-220V, etc.) and the attendant voltages/currents are contemplated for high(er) power systems.

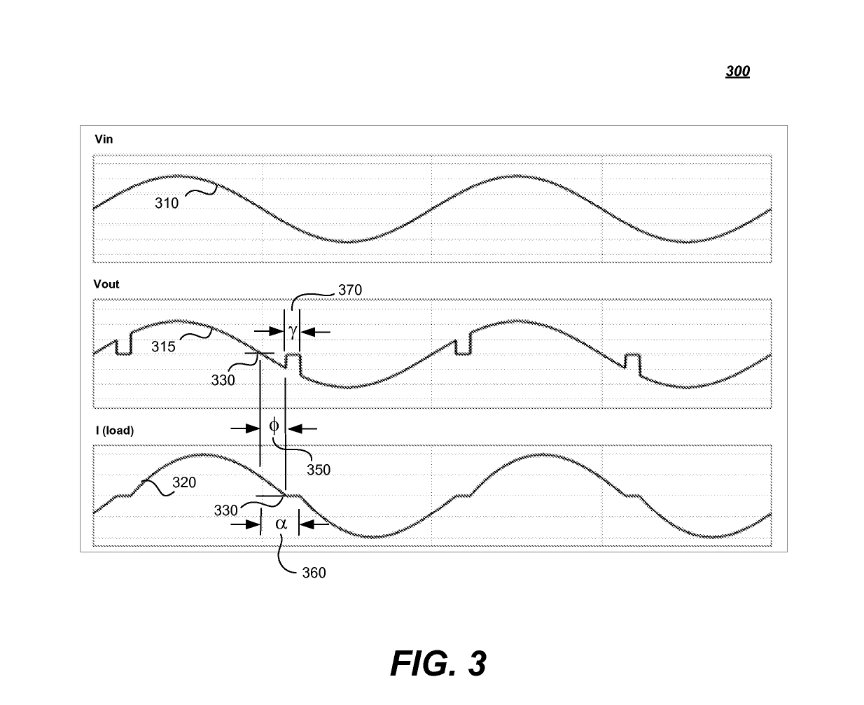

FIG. 3 is an illustration of instantaneous single phase voltage and current amplitude versus time plots 300 using the embodiment shown in FIG. 2A, under precise phase lag adjustment. Three phase operation is simply a replication of FIG. 3 for the additional phases, but in appropriate phase alignment. Therefore, the explanation presented here will be focused on a single phase, with the understanding it can be easily applied to three or more phase systems (e.g., FIG. 2B).

The voltage 310 is the voltage of the AC source, voltage 315 is the voltage out from the switch(es)/thyristor(s), and the current 320 is the current into the motor (referred here as load current). Steady state conditions are presumed, for this example. The phase lag φ 350 is understood as the difference in degrees between the voltage 315 and the current 320, easily seen here on the zero-crossings 330 of the time-axis. The firing angle α 360 is defined here as the sum of the phase lag φ 350 and chopping angle γ 370. The chopping angle γ 370 is understood as the “dead time” (degrees) wherein the voltage across motor terminals is zero which means power is stopped from flowing into the motor, via operation of the switch(es)/thyristor(s). The shutting off of the power to the motor effectively shifts the phase or decreases the current 320 lag when power is restored to the motor.

As noted above, decreasing the phase lag φ 350 decreases the subsequent power flow to the motor. But, recognizing that a given load's power draw is a function of the respective phase lag φ 350, it is possible to configure the chopping angle γ 370 to be adjusted to find the minimum of the power draw; in other words, reducing the RMS voltage of the motor and so reducing the core loss of the motor. To achieve this, the system “searches” for a lower power state, as compared to the previous state, in consideration of the affect on the phase lag φ 350.

This search can be performed in an iterative manner and can be as simple as a fixed increment/decrement step-wise adjustment, using an initial condition and adjusting the chopping angle γ 370, the step-wise amount to generate a new power state and comparing the value of the old condition with the new condition. If the new condition indicates a larger power value, then the chopping angle γ 370 is understood to be in the wrong direction and a reversal of the step-wise adjustment is initiated. If the new condition indicates a lower power value, then the chopping angle γ 370 is understood to be in the correct direction and the next adjustment value is performed. FIG. 3 presumes a steady state operation, but the illustrated principles can be equally applied to a non-steady state scenario, for example, a load change of the motor.

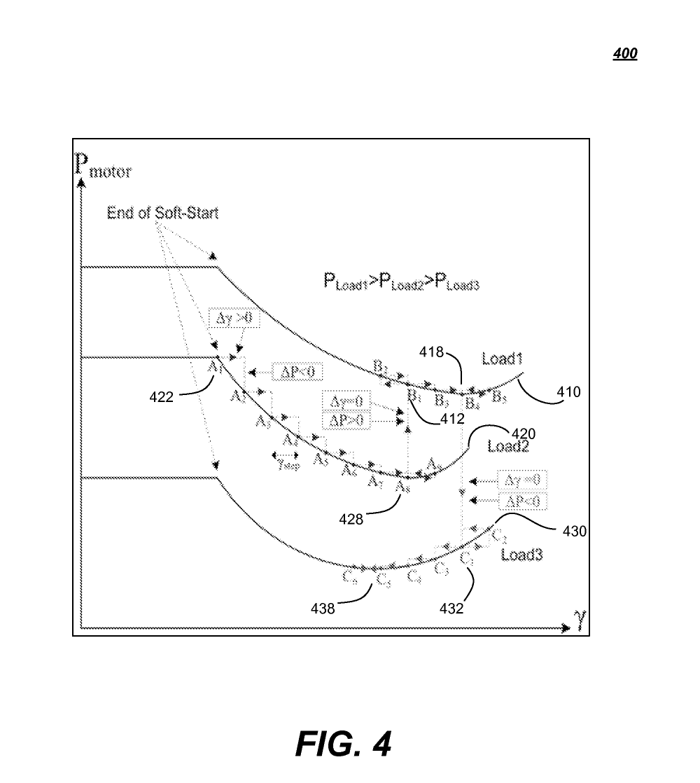

FIG. 4 is a graphical example 400 of power curves as a function of chopping angle γ for various loads, and the associated paths of fixed-increment/decrement chopping angle γ iterations to minimize the motor power loss or maximize motor efficiency. The iteration scheme for this example presumes steady state conditions (e.g., after soft start) have been established and shows three power load curves (410, 420, 430) with their respective minimums. Of course, the iteration scheme can be applied to a non-steady state scenario, non-soft starts, and more or less load states are possible.

Assume the motor starts with the power curve for load 2 (420) and based on control of the chopping angle γ, as determined from an initial phase lag angle φ, the path initially proceeds from A1 (422)→A2→A3→A4→A5→A6→A7→A8→A9→A8 (428) (noting in the last step that the wrong direction from A8 (428)→A9 is corrected by returning to A8 (428)). When the motor load changes (in this example from load 2 to load 1), the operating point shifts from A8 (428), on power curve for load 2 (420), to B1 (412), on power curve for load 1 (410) and the system starts iterating B1 (412)→B2→B1→B3→B4→B5→B4 (418). If the motor load shifts again from load 1 to load 3, the system operating point shifts from B4 (418), on power curve for load 1 (410) to C1 (432), on power curve for load 3 (430), and starts iterating C1 (432)→C2→C1→C3→C5→C6→C5 (438).

These iteration paths are minimization search paths, where C5 (438) represents the local minimum power point and the most efficient chopping angle γ (by extension—firing angle α) for the current motor load state. Therefore, such a system can be configured to operate at its minimum power state while still providing sufficient power to satisfy its load needs. It is anticipated that this approach can save up to 10% or more of the energy typically consumed in conventional systems, especially under low load conditions where the bulk of the losses are from core loss.

It should be understood that while FIG. 4 illustrates a fixed adjustment amount approach, the adjustment amount can be varied depending on the approach desired. For example, in some instances, if the “new” power value is less and very close to the “old” power value, the next adjustment value may be reduced to avoid oscillation around the minimum. Conversely, if the new power value is greater and very far from the “old” power value, the next adjustment value can be increased (and reversed) to accelerate to the minimum. Therefore, as is apparent, alternative minimization approaches such as higher order, non-linear, or variable approaches can be utilized without departing from the spirit and scope of this disclosure.

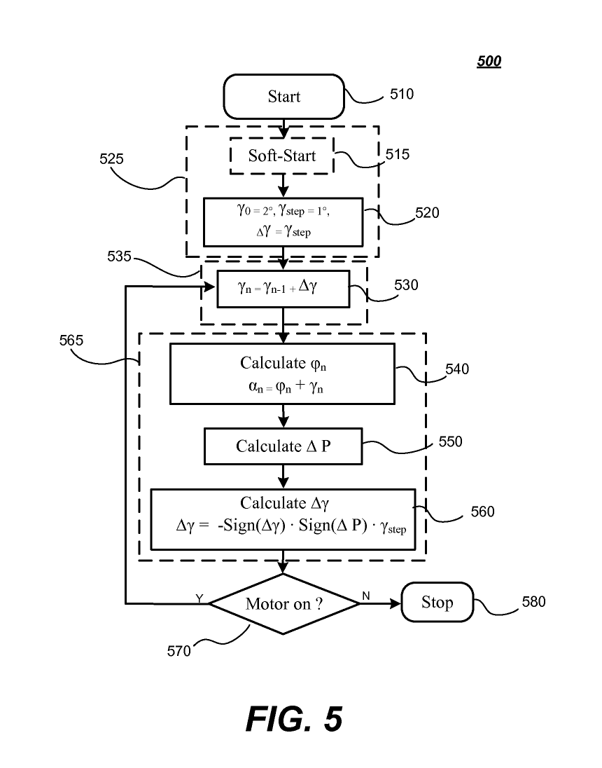

FIG. 5 is a flow chart illustrating an applicable process 500 for adjusting the chopping angle γ or firing angle α using a fixed adjustment amount approach. The process 500 enters into initialization module 525 after starting 510. The initialization module 525 may include a soft start procedure 515 and may not be implemented depending on design preference. Next, the initialization module 525 contains initial parameter setup and initial measurements 520, wherein the initial chopping angle γ₀ is arbitrarily designated here as 2 degrees, which is the γ value is presumed to be at the end of the (optional) soft start 515. This may be set to alternate value, according to design preference. Similarly, the chopping angle step Δγ is set to an arbitrary step value of 1 degree (γₛₜₑₚ=1 degree), understanding that other adjustment Δγ or γₛₜₑₚ value(s) may be used. The power (P₀) for this “reference/initial” state is measured and saved for later comparison with the subsequent power state. It is noted that power and phase lag in an AC power system are related so that power can be derived from knowledge of the phase lag and vice versus.

Next, in application module 535, the new chopping angle γₙ is computed 530 as γₙ=γₙ₋₁ (previous value)+Δγ (current step value) and applied to the subject system. This alters the phase lag φ of the system. The process 500 proceeds from the application module 535 to calculation and measurement module 565, to determine the phase lag φ in step 540. Having the phase lag φ and chopping angle γ values, the new chopping angle γ will be calculated and applied to the system. Next in step 550, the actual power for this new state (P₁) is determined from a power measurement (or phase lag equivalent determination). The change in power ΔP from this state (P₁) and the previous state P₀ is determined. The process 500 then proceeds to step 560 to calculate the next suitable “direction” for the new adjustment step Δγ using the relationship shown, where the Sign(f) function is defined as: =1, f≧0, and =1, f<0. This expression conveniently changes the sign of the adjustment step Δγ. Upon exiting calculation and measurement module 565, the process 500 checks in step 570 to see if the motor is still on. If on, the process 500 loops back to application module 535, calculates the new chopping angle γ in step 530 and proceeds. If, in step 570, the motor is deemed to be off or not in a power saving mode, the process terminates 580.

Expressed less technically, the firing angle of the system is adjusted (via chopping angle adjustment) which creates a new phase lag and a resulting new power. Based on this new power, a new chopping angle step is calculated. The chopping angle of the switch(es)/thyristor(s) is adjusted by the new chopping angle step amount and applied to the system. This in turn creates a new phase lag/power, whereupon a newer chopping angle step is calculated and the current firing angle is evaluated again. Consequently, the firing angle can be stepped up or stepped down for a particular load. If the power (or phase lag) decreases, the next firing angle is stepped in the same direction. But, if the power (or phase lag) increases, the next firing angle is stepped in the opposite direction. This process effectively iterates the firing angle to towards the minimum power (or phase lag).

It should be noted that while a fixed step approach is described above, non-fixed or higher order approaches may be applied, recognizing that there are numerous iterative schemes known in the art for finding a minimum. Further, the steps described above can be implemented as tangible coded instructions in a software controllable machine, such as a computer, microprocessor, etc.

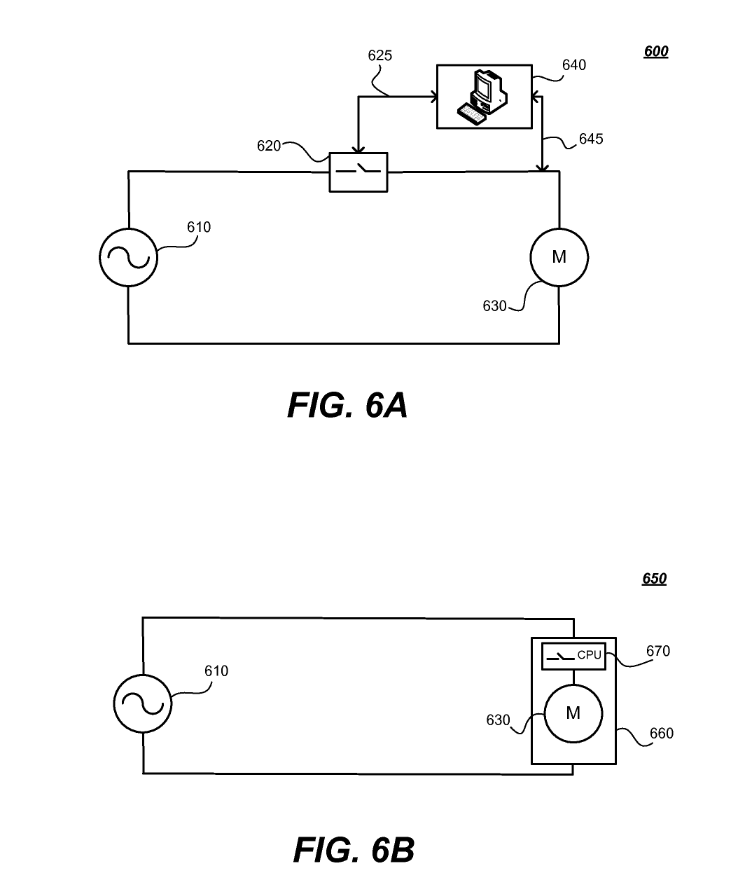

FIG. 6A is a block diagram 600 illustrating a motor system embodiment with a controller. AC source 610 is coupled to controllable switch(es) 620 which are managed by an automated controller 640 (shown here as a computer) via control link 625, which may be wired or wireless. Control link 625 may also operate as a measurement link to provide power/phase lag values to the automated controller 640. Optional measurement link 645, which may be wired or wireless, is facilitated between the automated controller 640 to the motor 620, to provide a secondary mechanism for power/phase lag measurement. The controllable switch(es) 620 control the flow of power to motor 620 in accordance with the processes and methods described herein, to result in a reduction of power losses, during operation of the motor 620. In some embodiments, the automated controller 640 may be remote from the system 600.

FIG. 6B is a block diagram 650 illustrating another embedded computer controlled embodiment, wherein the combination of the controllable switch(es) and controller 670 are embedded into the motor 630, as a self-contained unit 660. This embodiment contemplates the possibility that the motor 630 may be manufactured with the described switching/controller 670 as an integral part of the motor 630, and power tapping/measurement can be easily facilitated at the motor 630 side end.

While the above embodiments are principally discussed in the context of a single phase motorized system, it is expressly understood the embodiments are applicable to three-phase systems by the addition of controllable switch(es)/controller to the additional phase legs and coordination of the switch(es) as described above. For example, two additional controllable switch(es) can be added for the two extra phase legs found in a three phase power system and if the controller is equipped for multiple input/output operation, the additional inputs/outputs can be used to control the added switches/phase legs.

It is understood in the art that the term “angle” is equivalent to time, in the context of a synchronous system, such as an AC power system. For example, presuming 60 Hz (cycles per second) is the power cycle frequency, one cycle containing 360 degrees is equivalent to the passage of 1/60^{th} of a second. Therefore, 60 degrees would equate to 1/360 of a second. Accordingly, the above adjustments may be expressed in time increments, without departing from the spirit and scope thereof.

It should be noted that a system controller may be integrated into overall system or separate, being a computer or processing device under software operation. Therefore, as will be appreciated by one skilled in the art, the present disclosure may be embodied as an apparatus that incorporates some software components. Accordingly, some embodiments of the present disclosure, or portions thereof, may combine one or more hardware components such as microprocessors, microcontrollers, or digital sequential logic, etc., such as processor with one or more software components (e.g., program code, firmware, resident software, micro-code, etc.) stored in a tangible computer-readable memory device such as a tangible computer memory device, that in combination form a specifically configured apparatus that performs the functions as described herein. These combinations that form specially-programmed devices may be generally referred to herein “modules”. The software component portions of the modules may be written in any computer language and may be a portion of a monolithic code base, or may be developed in more discrete code portions such as is typical in object-oriented computer languages. In addition, the modules may be distributed across a plurality of computer platforms, servers, terminals, and the like. A given module may even be implemented such that the described functions are performed by separate processors and/or computing hardware platforms.

The foregoing is illustrative only and is not intended to be in any way limiting. Reference is made to the accompanying drawings, which form a part hereof. In the drawings, similar symbols typically identify similar components, unless context dictates otherwise.

Note that the functional blocks, methods, devices and systems described in the present disclosure may be integrated or divided into different combinations of systems, devices, and functional blocks, as would be known to those skilled in the art.

In general, it should be understood that the circuits described herein may be implemented in hardware using integrated circuit development technologies, or via some other methods, or the combination of hardware and software objects could be ordered, parameterized, and connected in a software environment to implement different functions described herein. For example, aspects of the present application may be implemented using a general purpose or dedicated processor running a software application through volatile or non-volatile memory. Also, the hardware objects could communicate using electrical signals, with states of the signals representing different data.

It should be further understood that this and other arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, implementations, and realizations, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those skilled in the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

What is claimed is:

1. An energy reducing device for an electrically powered motor, comprising:
at least one controllable electrical switch configured to be connected between an alternating power source and a motor driven by the alternating power source;
a processor in communication with the at least one controllable electrical switch, controlling a chopping angle operation thereof; and
processor-readable instructions for controlling the at least one controllable electrical switch, comprising:
an initialization module, assigning initial values for a chopping angle and adjustment step, and determining an initial motor power value;
an application module, applying an adjusted chopping angle, corresponding to the initial chopping angle plus the adjustment step, to the at least one controllable electrical switch;
a calculation and measurement module, calculating phase lag corresponding to the adjusted chopping angle, measuring current power value and calculating a difference between the current power value and a previous power value;
chopping angle adjustment module, adjusting the chopping angle according to the previous chopping angle step, adjustment step and calculated power difference; and
motor on module, determining, if a connected motor is on, to loop back to the application module with the adjusted chopping angle,
wherein the device reduces energy usage by iterating to a phase angle that is substantially at a minimum of a power usage curve for a motor load.

2. The device of claim 1, wherein the chopping angle adjustment module adjusts the chopping angle Δγ according to Δγ=−Sign(Δγ_{current})·Sign(ΔP)·γₛₜₑₚ, where Δγ_{current} is a current value, ΔP is the different between the current power value and previous power value, and the Sign(f) function is =1, f≧0, and =0, f<0.

3. The device of claim 1, wherein the adjustment step is variable.

4. The device of claim 1, wherein the at least one controllable electrical switch is a high voltage semiconductor switch and capable of controlling over a ¼hp motor and/or over 1 Kwatt of power.

5. The device of claim 1, wherein the at least one controllable electrical switch is comprised of a parallel pair of opposing thyristors.

6. The device of claim 1, further comprising, an alternating power source that is at least one of a single phase power source and multiple-phase power source coupled to the device.

7. The device of claim 1, further comprising, at least one of a single phase motor and multiple phase motor coupled to the device.

8. The device of claim 7, wherein at least one of the at least one controllable electrical switch and processor is embedded into the at least one single phase motor and multiple phase motor.

9. The device of claim 7, wherein the motor load is variable.

10. The device of claim 1, wherein the processor is in wireless communication with the at least one controllable electrical switch.

11. The device of claim 1, further comprising a power measurement tap separate from the at least one controllable electrical switch.

12. A method for reducing energy usage for an electrically powered motor, comprising:
connecting at least one controllable electrical switch between an alternating power source and a motor driven by the alternating power source;
connecting a processor in communication with the at least one controllable electrical switch, controlling a chopping angle operation thereof via the steps comprising:
automatically assigning, via processor instructions, initial values for a chopping angle and adjustment step, and determining an initial motor power value;
automatically applying, via processor instructions, an adjusted chopping angle, corresponding to the initial chopping angle plus the adjustment step, to the at least one controllable electrical switch;
automatically calculating, via processor instructions, a phase lag corresponding to the adjusted chopping angle;
automatically measuring, via processor instructions, current power value;
automatically calculating, via processor instructions, a difference between the current power value and a previous power value;
automatically adjusting, via processor instructions, the chopping angle according to the previous chopping angle step, adjustment step and calculated power difference; and
automatically determining, via processor instructions, if a connected motor is on, to loop back to the application module with the adjusted chopping angle,
wherein the method reduces energy usage by iterating to a phase angle that is substantially at a minimum of a power usage curve for a motor load.

13. The method of claim 12, wherein the automatically adjusting adjusts the chopping angle Δγ according to Δγ=−Sign(Δγ_{current})·Sign(ΔP)·γₛₜₑₚ, where Δγ_{current} is a current value, ΔP is the different between the current power value and previous power value, and the Sign(f) function is =1, f≧0, and =0, f<0.

14. The method of claim 13, wherein the adjustment step is variable.

15. The device of claim 12, wherein the at least one controllable electrical switch is a high voltage semiconductor switch and capable of controlling over a ¼hp motor and/or over 1 Kwatt of power.

16. The method of claim 12, further comprising, coupling at least one of a single phase power source and multiple-phase power source to a power source side of the at least one controllable electrical switch.

17. The method of claim 12, further comprising, coupling at least one of a single phase motor and multiple phase motor to a load side of the at least one controllable electrical switch.

18. The method of claim 12, wherein the processor is in wireless communication with the electrical switch.

19. The method of claim 17, further comprising, taking a power measurement at the motor.
